(19) United States
(12) Patent Application Publication
(10) Pub. No.: US 2009/0155469 A1
(43) Pub. Date: Jun. 18, 2009

(54) WATERLESS, LOW VOLATILE ORGANIC COMPOUND AND CARBON DIOXIDE EMISSION, MODULAR PAINT SYSTEM AND METHOD OF PERFORMING THE SAME

(75) Inventors: Julie N. Brown, Dearborn, MI (US); Glenn Williams, Holly, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Plastech Engineered Products, Inc., Dearborn, MI (US)

(21) Appl. No.: 11/958,789

(22) Filed: Dec. 18, 2007

(51) Int. Cl. B05D 3/00; B05C 11/02

(52) U.S. Cl. 427/314; 118/47

(57) ABSTRACT

The present invention is directed to a modular waterless, low VOC and CO₂ emission system to produce thermoplastic resin fascia and exterior components for automotive uses and a method of performing the same. The system and method disclosed have reduced environmental aspects and are adaptable to be used to accommodate any number of products.

### BACKGROUND OF THE INVENTION

Production of painted, finished thermoplastic fascia and exterior components in limited production numbers, or for mass production, has posed difficulties for suppliers of those components. In the past, facilities adapted to produce such articles required a large volume of product to make construction of such facilities cost effective. In addition, there are environmental concerns regarding CO₂ footprints, VOC's, and water contaminated with particulate materials from the paint process that required treatment and/or disposal. Because large product quantities were required to make production economically feasible, such production facilities tended to be constructed away from individual original equipment manufacturers but in geographical encatchment locations and transported significant distances to the automotive site under just in time manufacturing guidelines.

With the increasingly fractionated automotive market, smaller production runs are being made for more and difference models in an attempt by the Original Automotive Manufacturers to accommodate consumer's individual tastes. In addition increased environmental awareness and regulation have demanded a system and method to produce limited production quantities of different painted fascia etc., to accommodate such a varied production of automobiles at various sites. There is a need for a modular, waterless, low VOC and CO₂ emission system and method to produce to OEM specifications thermoplastic fascia and components such as automotive body side panels, grills, and bumpers, that is waterless, of low VOC and CO₂ emissions and reduces or eliminates transportation costs associated with Just in Time delivery of the painted fascia that can be expanded or contracted on site to accommodate various production requirements of many different models of automobiles.

### BRIEF SUMMARY OF THE INVENTION

In one aspect, the present invention relates to a waterless, low VOC and CO₂ emission method for preparing a cured, painted thermoplastic substrate. The method comprises treating a thermoplastic substrate with a flame applied nitrogen agent to form functional groups on the substrate conducive to paint adhesion, applying a self curing colored base coat paint to said substrate at a dry air filtration station, applying a self curing clear coat to the painted substrate at a dry air filtration station and accelerating cure in a hybrid oven.

The nitrogen agent is preferably selected from the group consisting of nitrogen gas or dithiolamine. The method may further include passing the painted substrate through an oven having infrared and convention heat to accelerate cross linking of the paint and curing of the clear coat to facilitate drying of the painted substrate within an accelerated time. The painted substrates are preferably a polypropylene thermoplastic substrate that is formed into automotive body side panels, bumpers, grills and bumpers. Generally, the time required to dry the painted substrate is from about 5 to about 10 minutes.

The filtration station includes a permanent rigid dry filter to cause air-born particulate matter to deposit on a first surface of said filter until a pressure sensor senses a predetermined pressure drop across the filter, after which air is directed through the filter from a second side opposite the first side to deposit collected particulate paint material into a receptacle for fluidizing and re-use as pre-filter media

In another aspect, the present invention relates to a waterless, modular, low VOC and CO₂ emission modular system to produce painted, cured thermoplastic resin substrates. The system is comprised of a treatment station having a flame source and a nitrogen source to apply nitrogen containing compounds to said substrate to form functional groups conducive to paint adhesion. Generally, the nitrogen source is selected from the group consisting of nitrogen gas or dithiolamine. The system further includes a paint station to apply a color base coat from a paint source to said substrate and a clear coat station to apply clear coat from a clear coat source to said base coated substrate. The system has a curing oven having infra red and convention heat sources to cure said painted substrate; said oven to apply heat to accelerate drying and curing time of said substrate. The part is generally moved from station to station by a conveyer or other mode of moving parts from one station to the next, and the curing time generally is in the range of from about 5 minutes to about 10 minutes.

The system further includes a waterless filtration system for capturing paint over-spray and particulate in close proximity to the paint station. The filtration system is generally coated with a layer of pre-filter dry particulate media to attach and hold dry or wet paint particulate matter. The rigid filtration system preferably has a Teflon coated filtration surface as the first surface on the structural element composition adapted to trap particulate matter of paint and pre-filter media. Each element cartridge in the filtration system is further equipped with a pressure sensor to detect a pressure drop across the filter such that, at a predetermined pressure drop, a pulse of air is forced through the filter from the second surface opposite the first surface to force the captured particulate matter into a receptacle for fluidizing and re-use as pre-filter media Thus, there is no need for water and chemicals to clean parts as a preparation for paint nor water and chemicals required to trap paint over-spray and particulate of the paint application process. In addition there is no requirement for an adhesion promoter to prepare for painting the parts nor is any gas consumed in heating the oven thereby, significantly reducing VOC and CO₂ emissions.

The modular system thus described may be configured to accommodate any number of fascia and exterior components from limited production number to mass production of fascia. In addition, because the system is modular, it may be constructed on site or in close proximity to the automotive manufacturing site and expanded or contracted as the product need dictates. Moreover, because it is on site or in close proximity to the manufacturing site, transportation costs and the investment in racking and packaging are eliminated or minimized.

### BRIEF DESCRIPTION OF THE DRAWINGS

FIG. 1 is a schematic representation of a modular hybrid infra-red and convection heat oven useful in the present invention.

FIG. 2 is a detailed sectional view of a filtration system useful in the present invention.

FIG. 3 is a schematic representation of a modular, waterless low VOC production system for painted thermoplastic resin substrates according to one aspect of the present invention.

FIG. 4 is a schematic flowchart representation of one method according to the present invention.

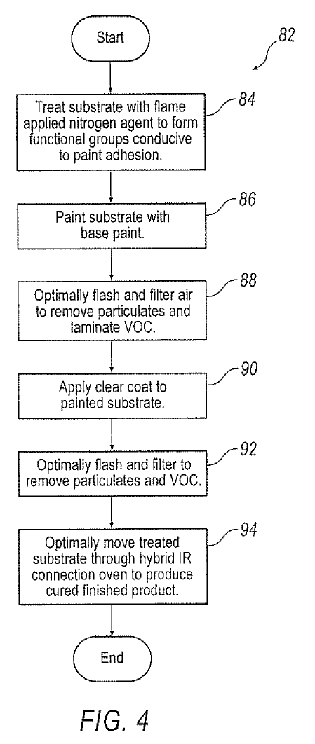

### DETAILED DESCRIPTION OF THE PREFERRED EMBODIMENT(S)

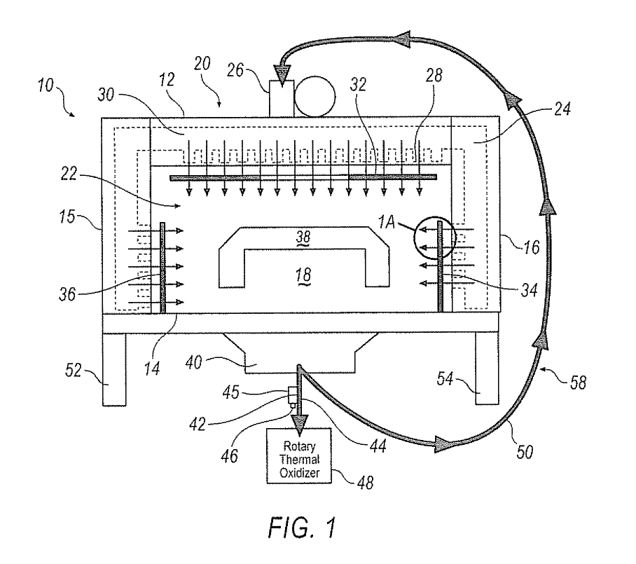

Turning now to the drawings wherein like numbers refer to like structures, and particularly to FIG. 1, there is depicted an infrared convection paint bake oven 10 is schematically presented in sectional form. Oven 10 has a top 12 and a bottom 14 substantially parallel to each other. The top and bottom are separated by sidewalls 15 and 16 that extend substantially parallel to each other and substantially unbroken therebetween to define a tunnel 18. The bottom has at least two, and preferably a series, of legs 52, 54 arranged periodically along its length. The tunnel has an exterior 20 and an interior 22. The sidewalls and top may be hollow and serve as ducts, or may be equipped with air ducts 24 that are connected to at least one air pressure blower unit 26 at one end and terminate in a series of openings 28 that communicate with the interior of the tunnel such that an air plenum 30 is formed to facilitate the movement of air from the blower through the ducts and passed over infra red lamps into the interior of the tunnel. A series of infrared lamp assemblies 32, 34, and 36 are arranged on the interior of the tunnel sidewalls and the top of the tunnel oriented to facilitate the heating of air to cure the finish or paint of an article 38 arranged in the tunnel interior. The oven is further equipped with an exhaust 40 on its bottom surface exterior and communicating with the interior of the tunnel so that moist hot air may be exhausted from the interior of the tunnel. A sensor 42 is arranged in a duct 44, and senses the presence of volatiles or particulate matter in the exhaust air and generates a signal to a computer 45 to control a valve 46 in the duct to vent the air through a furnace 48. The furnace heats the air and combusts the dust and or volatiles and vents the treated air through a common air duct 50 back to the air pressure blower for reintroduction into the interior of the tunnel to assist in the curing of the article to be treated. When there are no or insufficient volatiles or particulate matter, or moisture detected by the sensor, no signal is generated and the valve 46 remains closed, thereby venting the air through the common air duct 50 to the air pressure blower. The entire air duct valve, sensor furnace and return duct constitute an air recirculation system 58. Thus, it may be understood that the system is a closed system and the release of volatiles or particulate matter into the environment is greatly reduced or eliminated. The oven as described is set forth in pending in co-owned U.S. patent application Ser. No. 11/543,470 filed Oct. 5, 2006, incorporated herein by reference in its entirety.

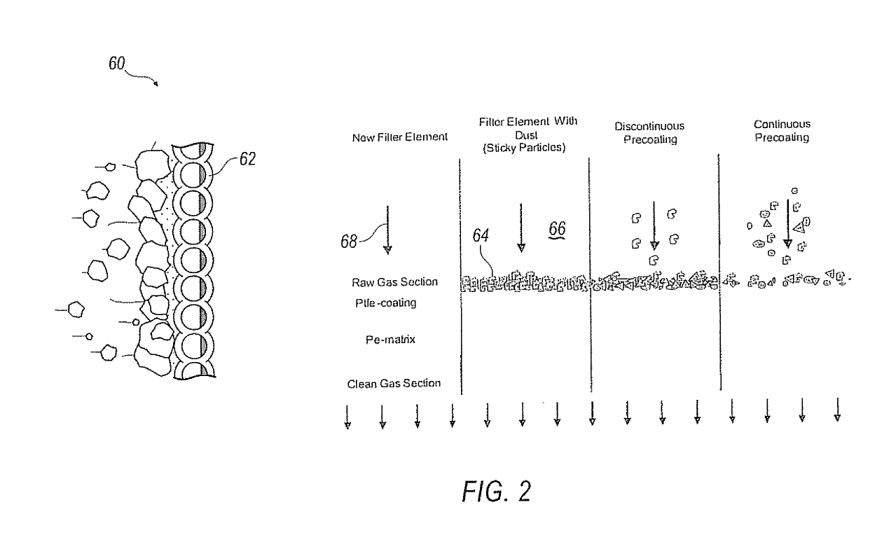

FIG. 2 is a detailed view of the filtration system used in accordance with the present invention. Specifically, surface filtration system 60 includes a filter element 62 that may be coated with a layer of dry pre-filter particles 64 on a first side 66 of the filter element. Arrow 68 is the direction of airflow across the filter element, so that particles and other particulate matter may be moved against the filter element. When particulate material contacts the pre-filter layer on the first side of the filter element, the particulate material becomes trapped by the pre-filter layer. As previously stated, an air pressure sensor measures the pressure drop across the filter element. The change in air pressure across the filter element is indicative of the amount of particulate material deposited on the first side of the filter element. At some point, the filtration element is substantially caked with particulate material and the pressure drop across the filter element reaches a predetermined set point, at which time, pressurized air is directed against a second side 70 of the filter element, which opposite the first side, and causes the layer with pre-filter particles and trapped particulate material to drop off the filter element to thereby present a non-caked filter element without the need to use water to scrub the particulate material from a the filtration element. Thus the system is waterless and eliminates the need to remove chemicals or other waste from a water source used to clean the filtration system.

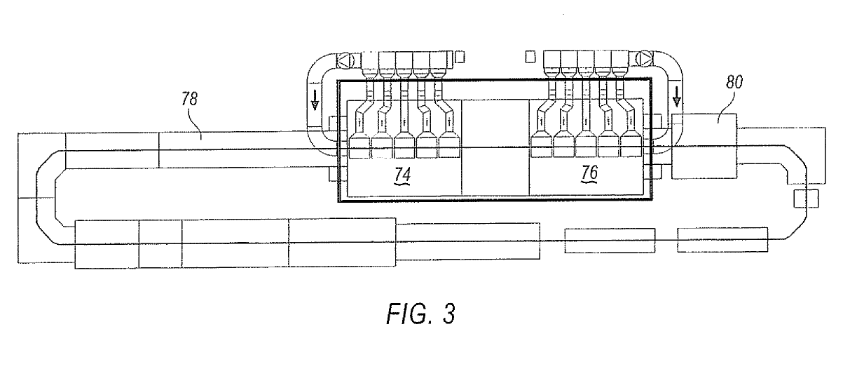

FIG. 3 is an overview of the modular system according to one aspect of the present invention. Specifically, the system includes a flame station 72, in close proximity to the paint station 74, to apply a nitrogen containing compound to the surface of a thermoplastic resin substrate, such as an automotive fascia for a grill, body side panel, or bumper. The thermoplastic resin may be a polypropylene based thermoplastic resin substrate, such as is customarily used in the automotive industry. The application of a nitrogen containing compound, such as nitrogen gas or dithiolamine creates function groups on the surface of the substrate to facilitate adhesion of the paint to the thermoplastic resin substrate surface. This process is customarily called the ATMAP process, available from FTS, LLC located in Flint, Mich.

Paint station 74 is in close proximity to clear coat station 76. Preferably, the system of the present invention is adapted to use a two component paint system, such as is available from BASF of Southfield, Mich. under the trade name 2K system. The paint station uses a base coat that may be pigmented and is applied to the nitrogen surface treated substrate as it moves on a conveyer 78 from the flame station to the paint station. Paint is applied from a paint source and a filtration system as previously described is used to ensure that particulate material is filtered from the air. The paint component of the 2K system from BASF is a self curing paint that will cross link and dry in a relatively short time. A flash station 80 may optionally be placed between the paint station and the clear coat station to permit flash of the painted substrate. The substrate is then moved to the clear coat station where the clear coat is applied. Note the filtration system as previously described in close proximity to the clear coat and the paint and the flash station to control any particulate or VOC that may occur during the painting, flashing and clear coating of the substrate. The part may them be moved to the hybrid infrared convection oven as previously described to be cured so that the resulting painted substrate product is completely cured in a minimal time of about 5 to 10 minutes.

The system as described is modular and may be sized to accommodate any number of production runs or parts. In addition, it may be increased in size or decreased in size and capacity to accommodate changes in production. Moreover, because it is a modular system it may be

| | | |
|---|---|---|
| ADPRO Station | 1.5 | — |
| ADPRO Flash off | 5.0 | — |
| ATmaP Station | — | 3.5 |
| Basecoat Station | 5.0 | 4.0 |
| Base Flash | 3.0 | 2.5 |
| Clear Station | 5.0 | 4.0 |
| Clear Flash | 6.0 | 6.0 |
| Cure Oven | 40.0 | 10.0 |
| Cool Down | 10.0 | 4.0 |
| Inspection/Off Load | 10.0 | 6.0 |
| Travel Only | — | 5.0 |
| Total: | 131.5 | 52.0 |

The words used to describe the invention are words of description not words of limitation. Those skilled in the art recognize that many variations are possible without departing from the scope and spirit of the invention as set forth in the appended claims.

What is claimed as new and desired to be protected by Letters Patent of the United States is:

1. A waterless, low volatile organic compound (VOC) and carbon dioxide (CO₂) emission method for preparing a cured, painted thermoplastic substrate, comprising:
a) treating said substrate with a flame applied nitrogen agent to form functional groups on the substrate conducive to paint adhesion;
b) applying a self curing base coat of paint to said substrate at an air filtered station; and
c) applying a clear coat to said painted substrate.

2. The method of claim 1, wherein said nitrogen agent is nitrogen gas or dithialamine.

3. The method of claim 1, further including passing said substrate through an oven having infrared and convention heat to accelerate cross linking of the paint and curing of the clear coat to facilitate drying of the painted substrate within an accelerated time.

4. The method of claim 3, wherein said time is from about 5 to about 10 minutes.

5. The method of claim 1, wherein said substrate is comprised of automobile fascia, bumpers, grills, or body side panels.

6. The method of claim 1, wherein said filtered station includes a dry filter to cause air-born particulate matter to deposit on a first surface of said filter until a pressure sensor senses a predetermined pressure drop across the filter, after which air is directed through the filter from a second side opposite the first side to deposit collected particulate paint material into a receptacle for fluidizing and re-use as pre-filter media

7. A waterless, low VOC and CO₂ emission, modular system to produce painted, cured thermoplastic resin substrates, comprising:
a treatment station having a flame source and a nitrogen source to apply nitrogen containing compounds to said substrate to form functional groups conducive to paint adhesion;
a paint station to apply a base coat from a paint source to said substrate;
a clear coat station to apply clear coat from a clear coat source to said base coated substrate;
a oven having infra red and convention heat sources to cure said painted substrate; said oven to apply heat to accelerate drying and curing time of said substrate.

8. The system of claim 7, wherein said time is from about 5 minutes to about 10 minutes.

9. The system of claim 7, further including a conveyor to move said substrates through said system.

10. The system of claim 7, further including a waterless filtration system in said paint station;
said filtration system coated with a layer of pre-filter media particles to attach and hold dry paint particulate matter; said filtration system in close proximity to said paint station' said filtration system having a filter agent equipped with a pre-filter layer on a first surface; said first surface adapted to trap particulate matter of dried paint and pre-filter media; said filtration system further equipped with a pressure sensor; said pressure sensor detects pressure drop across the filter such that, at a predetermined pressure drop, air if forced through the filer from a second surface opposite side first surface to deposit said particulate matter into a receptacle for fluidizing and re-use.

11. The system of claim 7, wherein said substrate is a polypropylene formed into an automotive fascia, bumper, grille or body side panel.
